(19) United States
(12) Patent Application Publication
(10) Pub. No.: US 2010/0188641 A1
(43) Pub. Date: Jul. 29, 2010

(54) PROJECTOR

(75) Inventors: Jiro MOMOSE, Shiojiri-shi (JP); Fumihide SASAKI, Matsumoto-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/686,802

(22) Filed: Jan. 13, 2010

(30) Foreign Application Priority Data
Jan. 27, 2009 (JP) 2009-015076

(51) Int. Cl. G03B 21/16

(52) U.S. Cl. 353/57

(57) ABSTRACT

A projector includes: a lighting device which includes a light source unit for emitting illumination light, and a light control device for controlling the amount of illumination light passing through the light control device by shielding a part of the light from the light source unit; a light modulation unit illuminated by illumination light emitted from the lighting device; and a projection system which projects image light having passed the light modulation unit, the lighting device has an air supply device configured to cool the light control device by cooling air supplied from the air supply device to a cross flow path which crosses an optical path passing the light control device.

The entire disclosure of Japanese Patent Application No. 2009-015076, filed Jan. 27, 2009, is expressly incorporated by reference herein.

### BACKGROUND

1. Technical Field

The present invention relates to a projector which modulates illumination light and projects the modulated light, and more particularly to a projector which includes a lighting device having a light control device for controlling the amount of illumination light.

2. Related Art

For example, a projector which includes a light control device having an opening and closing light shielding member for shielding a part of light emitted from a lamp light source is known (for example, see JP-A-2007-71913). The light control device is disposed between a first lens array and a second lens array provided for equalizing light to shield a part of illumination light traveling from the first lens array to the second lens array by rotating a pair of light shielding plates whose positions vary by rotation.

According to this projector, the light shielding plates are not actively cooled. In case of a high-intensity type projector recently developed, however, the heating amount of the light shielding plates is increasing, and particularly the temperature increase of the light shielding plates becomes extremely high during the maximum light shield. Thus, when gears and other driving units disposed around the light shielding plates are made of material such as resin, the driving units may be fused and brought into inoperable condition.

### SUMMARY

It is an advantage of some aspects of the invention to provide a projector capable of preventing breakage or other damages of a light control device caused by heating of a light shielding plate.

A projector according to an aspect of the invention includes: (a) a lighting device which includes a light source unit for emitting illumination light, and a light control device for controlling the amount of illumination light passing through the light control device by shielding a part of the light from the light source unit; (b) a light modulation unit illuminated by illumination light emitted from the lighting device; and (c) a projection system which projects image light having passed the light modulation unit. (d) The lighting device has an air supply device configured to cool the light control device by cooling air supplied from the air supply device to a cross flow path which crosses an optical path passing the light control device.

The projector having this structure includes the air supply device configured to cool the light control device by the cooling air supplied from the air supply device to the cross flow path which crosses the optical path passing the light control device. Thus, the light control device which easily raises its temperature at the time of light shielding can be cooled with high efficiency and space saving by utilizing the cooling air introduced to the cross flow path.

It is preferable that the air supply device cools the light source unit by supplying the cooling air having reached the cross flow path and cooled the light control device to the light source unit. In this case, the air supply device functions as a cooling device for the light source unit as well. Thus, size reduction of the projector can be easily achieved.

It is preferable that the light control device has a pair of plate-shaped light shielding members which are rotatable around a pair of rotation axes extending in directions perpendicular to an illumination axis extending along an optical path with the illumination axis interposed between the rotation axes, and extend in parallel with the pair of the rotation axes with the illumination axis interposed between the pair of the plate-shaped light shielding members. In this case, multi-stepped or continuous light amount control in a wide range for illumination light can be easily achieved by opening and closing the pair of the light shielding members as double doors opening outward.

It is preferable that the lighting device includes a first lens array having a plurality of lens elements for dividing light emitted from the light source unit into a plurality of partial lights, a second lens array having a plurality of lens elements corresponding to the plural lens elements of the first lens array, and a superimposing lens for superimposing the plural partial lights on an image forming area of the light modulation unit in cooperation with the second lens array. The pair of the plate-shaped light shielding members are disposed between the first lens array and the second lens array. In this case, lights after division by the first lens array and prior to superimposition can be shield, and thus the effect of the light amount control on equalization of illumination can be reduced.

It is preferable that the light control device includes a drive mechanism for operating the pair of the plate-shaped light shielding members, and a flow amount control unit interlocking with the pair of the light shielding members for controlling the degree of opening of the cross flow path. In this case, the cooling efficiency can be raised by increasing the flow amount when the light shielding amount produced by the light shielding members is large.

It is preferable that the air supply device has a cooling fan disposed at a position extended from the cross flow path provided for the light control device. In this case, cooling air to be supplied to the cross flow path by the cooling fan can be easily generated.

### BRIEF DESCRIPTION OF THE DRAWINGS

The invention will be described with reference to the accompanying drawings, wherein like numbers reference like elements.

FIG. 1 is a block diagram showing a structure of a projector according to an embodiment.

FIG. 2 is a perspective view showing a specific external appearance of a lighting device.

FIG. 3 is a side view of the lighting device whose flow amount control unit is disposed at a cooling position.

FIG. 4 is a side view of the lighting device whose flow amount control unit is disposed at a closing position.

FIG. 5 is a perspective view showing a structure of a light control device.

### DESCRIPTION OF EXEMPLARY EMBODIMENT

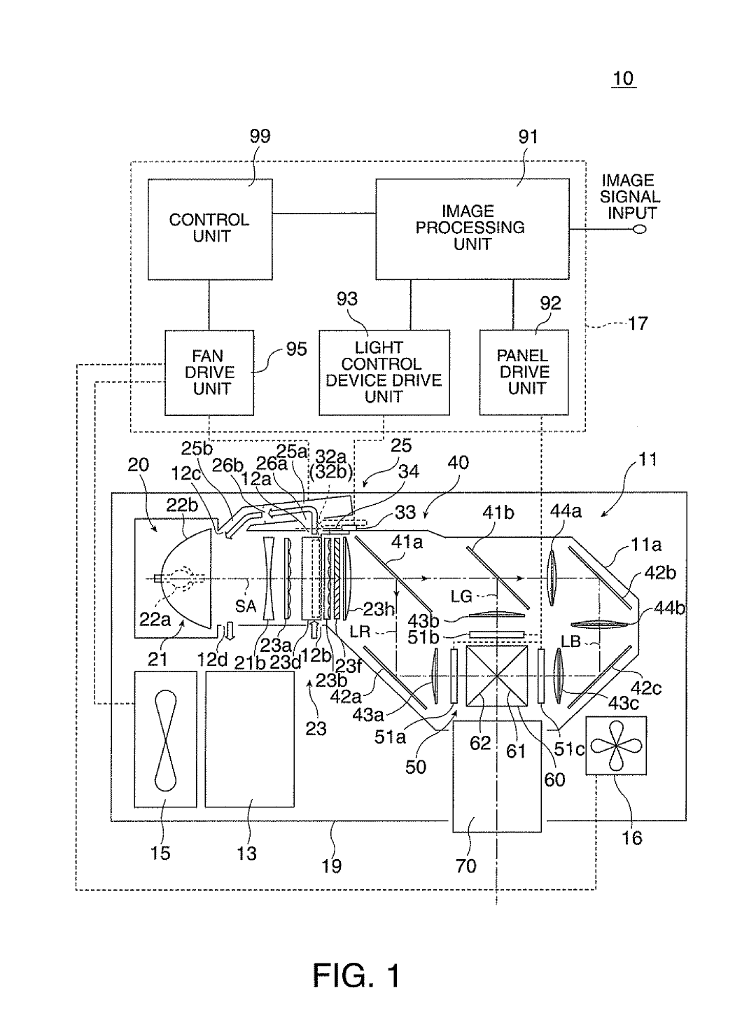

FIG. 1 is a block diagram showing a concept of a projector according to an embodiment of the invention.

A projector 10 includes a main optical apparatus 11 called optical engine unit as well, a power source device 13 for supplying power to a lamp light source and the like, a circuit device 17 for controlling the overall operation of the system, and an outer case 19 for covering the entire system. The circuit device 17 has electronic components mounted on a printed circuit board. The circuit device 17 is disposed at an appropriate position inside the outer case 19, but is shown outside the outer case 19 in the figure for easy understanding of the figure.

The main optical apparatus 11 includes a lighting device 20, a color separation and light guide system 40, a light modulation unit 50, a cross dichroic prism 60, and a projection system 70. Almost all parts of the lighting device 20, the color separation and light guide system 40, the light modulation unit 50, the cross dichroic prism 60, and the projection system 70 are accommodated in a case member 11a having light shielding function. The case member 11a forms an optical path along which optical components are disposed, and is called “light guide” as well.

The lighting device 20 has a light source lamp unit 21, an equalizing system 23, and a cooling fan unit 25.

The light source lamp unit 21 has a light source section containing a lamp 21a and a concave lens 21b. The lamp 21a has a lamp main body 22a constituted by a high-pressure mercury lamp or the like, and a concave mirror 22b for collecting light from the light source and releasing the collected light toward the front. The concave lens 21b has a function of converting the light from the lamp 21a of the light source into light substantially parallel with a system optical axis SA, i.e., illumination optical axis. However, when the concave mirror 22b is a parabolic mirror, the concave lens 21b may be eliminated.

The equalizing system 23 has first and second lens arrays 23a and 23b, a light control device 23d, a polarization conversion member 23f, and a superimposing lens 23h. Each of the first and second lens arrays 23a, 23b has a plurality of element lenses disposed in matrix. Light emitted from the light source lamp unit 21 is divided into a plurality of partial lights by the element lenses of the first lens array 23a. The respective partial lights from the first lens array 23a are released through the elements lenses of the second lens array 23b at appropriate divergence angles. The light control device 23d has a pair of upper and lower plate-shaped light shielding plates 32a and 32b extending in the horizontal direction, and a drive mechanism 33 for opening and closing the light shielding plates 32a and 32b. The light control device 23d can shield illumination light traveling along the optical path from the first lens array 23a to the second lens array 23b to a desired level by rotating the pair of the light shielding plates 32a and 32b as a pair of light shielding members around rotation axes extending in the horizontal direction by using the drive mechanism 33. Though the details are not explained herein, the polarization conversion member 23f has a prism array containing a PBS and a mirror, and a wavelength plate array in the shape of stripes affixed to an emission surface formed on the prism array. The polarization conversion member 23f converts the light released from the light source and the lens array 23b into only linear polarized light in a first polarization direction parallel with the sheet surface of FIG. 1, for example, and supplies the converted light to the subsequent optical system. The superimposing lens 23h converges the overall illumination light having passed through the polarization conversion member 23f to superimpose the illumination light on liquid crystal light valves 51a, 51b, and 51c for respective colors provided on the light modulation unit 50.

The cooling fan unit 25 has a cooling fan 25a and an airflow path 25b as an air supply device. While a sirocco fan is used as the cooling fan 25a in this embodiment, an axial fan or other various types of airflow unit may be employed. An air inlet port 26a of the cooling fan 25a is disposed opposed to an opening 12a as one of openings 12a and 12b formed on the case member 11a. The openings 12a and 12b are disposed at positions corresponding to both end positions of the light shielding plates 32a and 32b in the light shielding condition. At the time of cooling the light control device 23d, cooling air is introduced from the outside of the case member 11a through the opening 12b into the case member 11a, and passes a cross flow path along the light shielding plates 32a and 32b. Then, the cooling air is guided to the outside of the case member 11a via the opposite opening 12a, and is sucked into an intake port 26a of the cooling fan 25a. Thus, at the time of cooling the light control device 23d, the air discharged after cooling the light shielding plates 32a and 32b is supplied to the cooling fan 25a and recycled for the lamp 21a as will be described later. An airflow port 26b of the cooling fan 25a communicates with an opening 12c formed on the case member 11a via the airflow path 25b to supply the cooling air to the lamp 21a. The air heated after cooling the lamp 21a is discharged to the outside of the case member 11a via an opening 12d formed on the case member 11a at a position opposed to the opening 12c.

The light control device 23d has a flow amount control unit 34 interlocked with the light shielding plates 32a and 32b to control the degree of opening of the cross flow path by adjusting the position of the flow amount control unit 34 according to the open/close condition of the light shielding plates 32a and 32b. More specifically, the flow amount control unit 34 is disposed at a cooling position for cooling the light control device 23d under an operation condition in which the light shielding plates 32a and 32b shield a part of the optical path, and the flow amount control unit 34 is disposed at a closing position for preventing cooling of the light control device 23d under a withdrawal condition in which the light shielding plates 32a and 32b open the optical path. When the flow amount control unit 34 is disposed at the cooling position, the flow amount control unit 34 is withdrawn from the opening 12a to open the opening 12a. As a result, the cooling air passes the cross flow path along the light shielding plates 32a and 32b in such a direction as to cross the optical path to cool the light shielding plates 32a and 32b. On the other hand, when the flow amount control unit 34 is disposed at the closing position, the flow amount control unit 34 closes the opening 12a. As a result, cooling air outside the case member 11a (indicated by a dotted arrow) is directly taken into the cooling fan 25a.

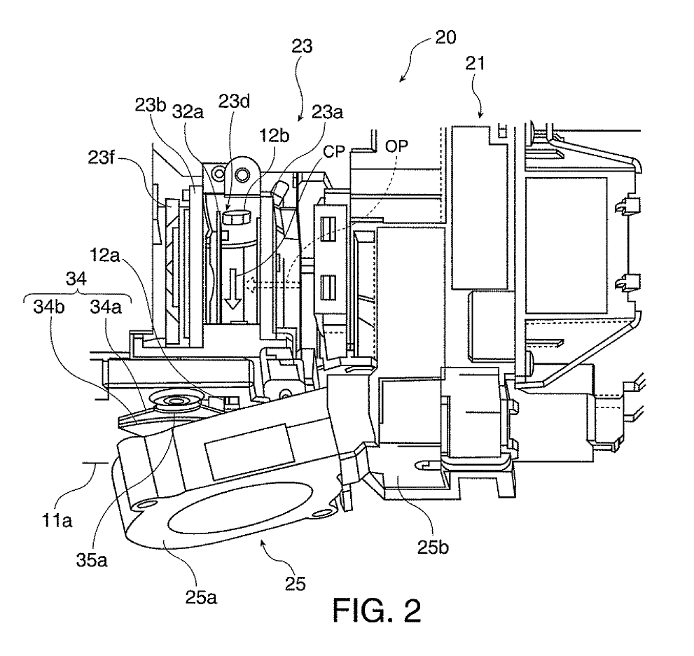

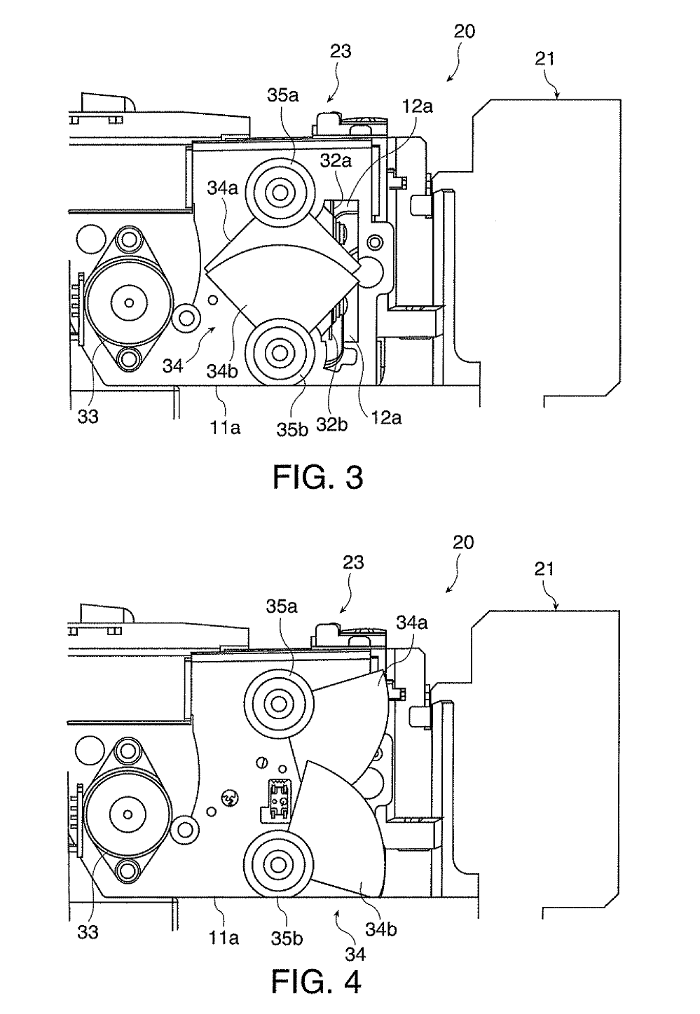

FIG. 2 is a perspective view showing the specific external appearance of the lighting device 20 from which a part of the upper part of the case member 11a is removed. FIG. 3 is a side view of the lighting device 20 when the flow amount control unit 34 is disposed at the cooling position. FIG. 4 is a side view of the lighting device 20 when the flow amount control unit 34 is disposed at the closing position.

As shown in FIG. 2, a cross flow path CP crossing an optical path OP is formed between the openings 12a and 12b of the case member 11a. The cross flow path CP is disposed adjacent to the light shielding plates 32a and 32b in the operation condition. A pair of flow amount control plates 34a and 34b of the flow amount control unit 34 are attached to the side of the opening 12a of the case member 11a. As shown in FIGS. 3 and 4, the flow amount control plates 34a and 34b are rotatable around rotation shaft members 35a and 35b equipped for the light shielding plates 32a and 32b in such a manner as to rotate along with the light shielding plates 32a and 32b. In case of the condition shown in FIG. 3, the flow amount control unit 34 is located at the cooling position in which both the flow amount control plates 34a and 34b overlap with each other in the vertical direction. In this case, substantially the entire area of the opening 12a is opened, and a flow path extending along the light shielding plates 32a and 32b at the operation position is produced. In case of the condition shown in FIG. 4, the flow amount control unit 34 is disposed at the closing operation. In this condition, the upper flow amount control plate 34a is rotated anticlockwise through about 45 degrees, and the lower flow amount control plate 34b is rotated clockwise through about 45 degrees. In this case, the overlapping portion of the flow amount control plates 34a and 34b decreases to close the opening 12a, and the flow path formed between the light shielding plates 32a and 32b located at the withdrawal position is cut off. Though not shown in the figure, the opening 12a is partially opened in an intermediate condition between the conditions shown in FIGS. 3 and 4. In the intermediate condition, a flow path corresponding to the degree of opening of the opening 12a is formed along the light shielding plates 32a and 32b. Thus, the amount of the air flowing through the flow path along the light shielding plates 32a and 32b can be increased or decreased according to the light shielding amount of the light shielding plates 32a and 32b.

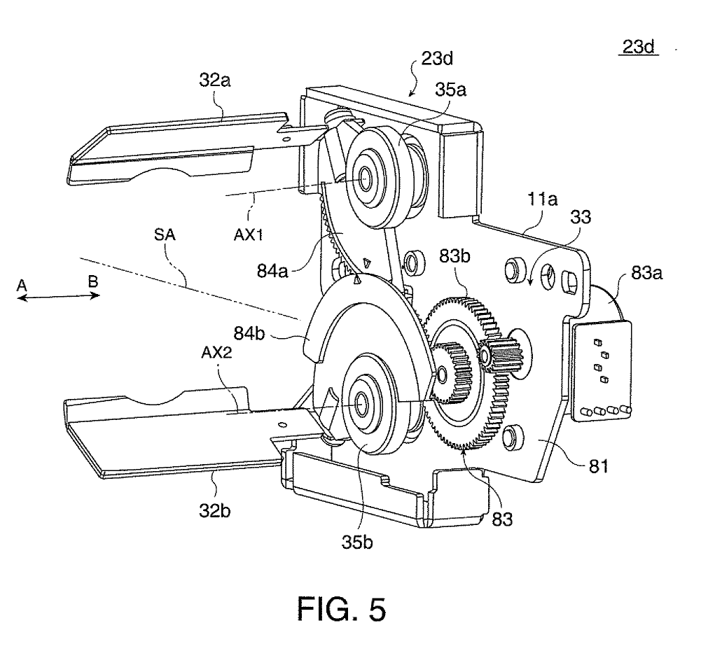

FIG. 5 is a perspective view showing the structure of the light control device 23d, showing the condition of the light control device 23d as viewed from the upstream side of the optical path. The light control device 23d includes a fixing member 81, the light shielding plates 32a and 32b, the rotation shaft members 35a and 35b, and the drive mechanism 33. The fixing member 81 forms a part of the case member 11a as light guide, and supports the rotation shaft members 35a and 35b and the drive mechanism 33. The pair of the light shielding plates 32a and 32b supported by the pair of the rotation shaft members 35a and 35b extend in a horizontal A-B direction perpendicular to the system optical axis SA. The light shielding plates 32a and 32b are disposed opposed to each other with the system optical axis SA interposed therebetween and symmetric with each other with respect to the system optical axis SA. The pair of the light shielding plates 32a and 32b are rotatable around rotation axes AX1 and AX2, respectively. The drive mechanism 33 has a motor 83a, a transmission member 83b, and a pair of drive gears 84a and 84b. The rotation of the motor 83a is transmitted to the pair of the drive gears 84a and 84b via the transmission member 83b. By the rotation of the upper drive gear 84a and the lower drive gear 84b in opposite directions in synchronization with each other, the light shielding plates 32a and 32b fixed to the pair of the drive gears 84a and 84b are rotated accordingly in synchronization with each other. In this case, the light shielding plates 32a and 32b attached at positions away from the rotation axes AX1 and AX2 approach the system optical axis SA to come to the operation condition, i.e., the light shielding condition (hidden) or move away from the system optical axis SA to come to the withdrawal condition, i.e., the non-shielding condition (displayed) according to the normal rotation or reverse rotation of the motor 83a.

Returning to FIG. 1, the color separation and light guide system 40 includes first and second dichroic mirrors 41a and 41b, reflection mirrors 42a, 42b, and 42c, and three field lenses 43a, 43b, and 43c to divide illumination light emitted from the lighting device 20 into illumination lights in three colors of red (R), green (G), and blue (B) and guide the respective illumination lights to the subsequent liquid crystal light valves 51a, 51b, and 51c. More specifically, the first dichroic mirror 41a initially reflects illumination light LR in R color included in the three R, G, and B color lights and transmits illumination lights LG and LB in G and B colors. The second dichroic mirror 41b reflects the illumination light LG in G color included in the two G and B color lights and transmits the illumination light LB in B color. In the color separation and light guide system 40, the illumination light LR reflected by the first dichroic mirror 41a passes the reflection mirror 42a and enters the field lens 43a for incident angle control. The illumination light LG transmitted by the first dichroic mirror 41a and reflected by the second dichroic mirror 41b enters the field lens 43b for incident angle control. The illumination light LB transmitted by the second dichroic mirror 41b passes relay lenses 44a and 44b and the reflection mirrors 42b and 42c and enters the field lens 43c for incident angle control.

The light modulation unit 50 has the three liquid crystal light valves 51a, 51b, and 51c receiving the three illumination lights LR, LG, and LB, respectively. Though not shown in the figure, each of the liquid crystal light valves 51a, 51b, and 51c has a liquid crystal panel disposed at the center and a pair of entrance side and exit side polarization filters disposed on both sides of the liquid crystal panel. The liquid crystal light valves 51a, 51b, and 51c having received the respective color lights LR, LG, and LB from the entrance side polarization filters vary the spatial distributions of the color lights LR, LG, and LB in the polarization direction. More specifically, the respective polarization conditions of the color lights LR, LG, and LB having entered the liquid crystal light valves 51a, 51b, and 51c are controlled for each pixel according to drive signals or control signals inputted to the liquid crystal light valves 51a, 51b, and 51c as electric signals. Then, the intensities of the color lights LR, LG, and LB are modulated for each pixel while passing through the not-shown exit side polarization filters.

The cross dichroic prism 60 is a light combining system for producing a color image, and contains a first dichroic film for R light reflection (more specifically, a dielectric multilayer film) 61, and a second dichroic film for B light reflection (more specifically, a dielectric multilayer film) 62 disposed in X shape. The cross dichroic prism 60 reflects the red light LR coming from the liquid crystal light valve 51a by using the first dichroic film 61 such that the red light LR can be released on the right side with respect to the traveling direction, directs the green light LG coming from the liquid crystal light valve 51b by using both the dichroic films 61 and 62 such that the green light LG can be released in the straight direction, and reflects the blue light LB coming from the liquid crystal light valve 51c by using the second dichroic film 62 such that the blue light LB can be released on the left side with respect to the traveling direction.

The image light combined by the cross dichroic prism 60 in this manner passes a projection lens as the projection system 70 to be projected on a screen (not shown) by an appropriate expansion rate as a color image.

The power source device 13 turns on the lamp main body 22a provided on the light source lamp unit 21 to allow emission of light having desired luminance, and supplies appropriate power to cooling fan units 15 and 16 and the circuit device 17.

The cooling fan unit 15 having a fan, a motor and the like discharges an appropriate flow amount of air in response to control signals from the circuit device 17. The cooling fan unit 15 is disposed in the vicinity of the light source lamp unit 21 and the power source device 13 receiving the maximum heat to directly discharge air having cooled the lamp 21a, the power source device 13 and the like to the outside of the outer case 19. On the other hand, the cooling fan unit 16 having a fan, a motor, a dustproof filter and the like introduces an appropriate flow amount of air in response to control signals from the circuit device 17. An airflow circulating within the outer case 19 is formed by the cooling fan units 15 and 16 and the cooling fan unit provided on the lighting device 20 such that particularly the liquid crystal light valves 51a, 51b, and 51c can be cooled by the cooling fan unit 16 for preference, and that heating other components by the air having cooled the lamp 21a can be prevented by the cooling fan unit 15.

The circuit device 17 includes an image processing unit 91 to which external image signals such as video signals are inputted, a panel drive unit 92 for driving the respective liquid crystal light valves 51a, 51b and 51c based on the output from the image processing unit 91, a light control device drive unit 93 for driving the light control device 23d based on the output from the image processing unit 91, a fan drive unit 95 for operating the cooling fan units 15, 16 and 25 according to detection results from a not-shown temperature sensor or switch, and a main control unit 99 for controlling the operations of the circuit sections 91, 95 and the like.

The image processing unit 91 of the circuit device 17 corrects inputted external image signals and displays character information and the like shown in place of the external image signals or superimposed on the external image signals.

The panel drive unit 92 produces drive signals for controlling the conditions of the liquid crystal light valves 51a, 51b, and 51c based on the image signals processed and outputted from the image processing unit 91. The drive signals are used to form an image having transmissivity distribution corresponding to the image signals inputted from the image processing unit 91 by using the liquid crystal light valves 51a, 51b, and 51c.

The light control device drive unit 93 controls the operation condition of the light control device 23d to continuously or steppedly switch between the operation condition for cutting off a part of the optical path by using the light shielding plates 32a and 32b and the withdrawal condition for opening the optical path by using the light shielding plates 32a and 32b.

The fan drive unit 95 for actuating the cooling fan units 15, 16 and 25 by feedback control or the like controls the number of revolution of the fans provided on the cooling fan units 15, 16 and 25 based on the temperature detected by the temperature sensor provided on the lamp 21a, the temperature detected by the temperature sensor provided at an appropriate position inside the outer case 19, and other conditions.

The main control unit 99 has a microcomputer to operate under a program prepared for controlling the image processing unit 91 and others. The light control operation performed by the projector 10 is now explained. When a video signal is inputted to the projector 10 through an image signal input terminal, the image processing unit 91 detects a luminance peak value of an image from the video signal and outputs the detected peak value to the main control unit 99, and converts the resolution of the video signal into resolution matched with the pixel numbers of the liquid crystal light valves 51a, 51b and 51c. In this case, the image processing unit 91 controls a luminance signal in the video signal based on a command from the main control unit 99. The main control unit 99 determines a gain control amount based on the luminance peak value of the image obtained from the image processing unit 91, and returns the result to the image processing unit 91. For example, when the luminance peak value of the image reaches 50% as the upper limit of the luminance allowed to be inputted to the projector 10, the contrast after elapse of time can be increased by decreasing the amount of illumination on the liquid crystal light valves 51a, 51b and 51c to 50% and increasing the black display capability of the liquid crystal light valves 51a, 51b, and 51c. For this purpose, the image processing unit 91 operates the light control device 23d based on the gain control amount obtained from the main control unit 99 to decrease illumination light on the liquid crystal light valves 51a, 51b and 51c. When the light control device 23d is brought into the operation condition by the image processing unit 91, the light shielding plates 32a and 32b are positioned on the optical path and heated thereon. In this case, the flow amount control unit 34 interlocking with the light shielding plates 32a and 32b is disposed at an appropriate position between the cooling position for opening the opening 12a and the closing position for closing the opening 12a with the degree of opening appropriately controlled. By this method, a flow amount of cooling air corresponding to the light shield amount of the light shielding plates 32a and 32b can pass through the cross flow path CP along the light shielding plates 32a and 32b and cool the light shielding plates 32a and 32b efficiently.

As obvious from this description, the lighting device 20 of the projector 10 according to this embodiment has the cooling fan unit 25 as the air supply device, and the cooling fan unit 25 as the air supply device supplies cooling air to the cross flow path CP which crosses the optical path passing the light control device 23d to cool the light control device 23d. By this method, the light control device 23d which easily raises its temperature at the time of light shielding can be cooled with high efficiency and space saving by utilizing the cooling air introduced to the cross flow path CP.

The invention is not limited to the embodiment described herein but may be practiced otherwise without departing from the scope and spirit of the invention. For example, the following modifications may be made.

According to this embodiment, the light control device 23d has the opening and closing light shielding plates 32a and 32b as double doors opening outward. However, the light control device 23d capable of switching between plural opening sizes by sliding a pair of masks having strip-shaped openings may be used.

According to this embodiment, the cooling fan unit 25 cools both the lamp 21a and the light control device 23d. However, the lamp 21a and the light control device 23d may be separately cooled by using separate air supply devices.

While the lamp main body 22a contained in the light source lamp unit 21 is constituted by high-pressure mercury lamp in this embodiment, the lamp main body 22a may be a metal halide lamp or the like.

According to the embodiment, the pair of the lens arrays 23a and 23b are employed for dividing light from the light source lamp unit 21 into plural partial lights. However, the invention is applicable to a projector including no lens array. It is also possible to replace the lens arrays 23a and 23b with a rod integrator.

While the polarization conversion member 23f for converting light from the light source lamp unit 21 and the like into polarized light in a particular direction has been used in this embodiment, the invention is applicable to a projector not including the polarization conversion member 23f.

While the invention has been applied to the transmission-type liquid crystal light valves 51a, 51b, and 51c in this embodiment, the invention is applicable to a reflection-type liquid crystal light valve. The “transmission-type” liquid crystal light valve herein refers to a type which transmits light, and the “reflection-type” liquid crystal light valve refers to a type which reflects light.

The structure of the projector shown in FIG. 1 and other figures is applicable to both a front projection type projector which projects images in the projection surface viewing direction and a rear projection type projector which projects images in the direction opposite to the projection surface viewing direction.

According to this embodiment, respective color lights are modulated by using the color separation and light guide system 40, the liquid crystal light valves 51a, 51b, and 51c and others. However, the color light modulating and combining processes may be performed by using a combination of color wheel illuminated by the lighting device 20 and a device (light modulation unit) having micromirror pixels and receiving transmission light from the color wheel.

What is claimed is:

1. A projector comprising:
a lighting device which includes a light source unit for emitting illumination light, and a light control device for controlling the amount of illumination light passing through the light control device by shielding a part of the light from the light source unit;
a light modulation unit illuminated by illumination light emitted from the lighting device; and
a projection system which projects image light having passed the light modulation unit,
the lighting device has an air supply device configured to cool the light control device by cooling air supplied from the air supply device to a cross flow path which crosses an optical path passing the light control device.

2. The projector according to claim 1, wherein the air supply device cools the light source unit by supplying the cooling air having reached the cross flow path and cooled the light control device to the light source unit.

3. The projector according to claim 1, wherein the light control device has a pair of plate-shaped light shielding members which are rotatable around a pair of rotation axes extending in directions perpendicular to an illumination axis extending along an optical path with the illumination axis interposed between the rotation axes, and extend in parallel with the pair of the rotation axes with the illumination axis interposed between the pair of the plate-shaped light shielding members.

4. The projector according to claim 3, wherein the lighting device includes a first lens array having a plurality of lens elements for dividing light emitted from the light source unit into a plurality of partial lights, a second lens array having a plurality of lens elements corresponding to the plural lens elements of the first lens array, and a superimposing lens for superimposing the plural partial lights on an image forming area of the light modulation unit in cooperation with the second lens array; and
the pair of the plate-shaped light shielding members are disposed between the first lens array and the second lens array.

5. The projector according to claim 3, wherein the light control device includes a drive mechanism for operating the pair of the plate-shaped light shielding members, and a flow amount control unit interlocking with the pair of the light shielding members for controlling the degree of opening of the cross flow path.

6. The projector according to claim 1, wherein the air supply device has a cooling fan disposed at a position extended from the cross flow path provided for the light control device.
